(19) United States
(12) Patent Application Publication
(10) Pub. No.: US 2011/0222823 A1
(43) Pub. Date: Sep. 15, 2011

(54) OPTICAL CONNECTOR AND A METHOD OF CONNECTING A USER CIRCUIT TO AN OPTICAL PRINTED CIRCUIT BOARD

(75) Inventor: Richard C.A. Pitwon, Fareham (GB)

(73) Assignee: XYRATEX TECHNOLOGY LIMITED, Havant (GB)

(21) Appl. No.: 12/722,908

(22) Filed: Mar. 12, 2010

(51) Int. Cl. G02B 6/36

(52) U.S. Cl. 385/93; 385/88

(57) ABSTRACT

The invention provides an optical connector for connecting a user circuit to an optical backplane, in which the backplane has one or more waveguides on it for carrying optical signals, the connector comprising: a first optical interface provided on the user circuit for receiving optical signals from the backplane or for transmitting optical signals for passage along the one or more waveguides; a second optical interface provided on the backplane for receiving optical signals from the user circuit or for transmitting optical signals to the user circuit; alignment features provided on each of the user circuit and the backplane arranged to align the first and second optical interfaces such that upon insertion of the user circuit to the backplane, the optical interfaces are aligned in the direction of insertion.

The present invention relates to an in-plane optical connector for connecting a user circuit to an optical printed circuit board (PCB) and a method of connecting a user circuit to an optical PCB. In embodiments, the invention relates to a method and connector for connecting a user circuit to an optical backplane.

As used herein, the term “optical PCB” relates to a PCB that includes optical channels and/or optical components. An optical PCB can be solely optical, in that it does not contain non-optical connections and channels, or it might include electrical channels and components in addition to the optical functionality it provides.

In our granted U.S. Pat. No. 7,625,134 (the entire contents of which are hereby incorporated by reference) there is disclosed an optical connector for connecting a user circuit to an optical backplane. The connector works well. There is provided an optical connector for connecting a user circuit to an optical backplane, in use the connector being adapted for mounting on a user circuit. The connector comprises an active or passive photonic interface through which optical signals may be transmitted and received between a user circuit and a said optical backplane.

The connector includes a primary aligner for engagement with a corresponding aligner on a backplane to ensure alignment of the optical interface with the backplane, and a support for supporting the aligner and/or the optical interface on the connector. The support is selected to enable relative movement between a user circuit to which the connector is connected in use and the aligner and/or the optical interface. The support is preferably a flexible printed circuit board.

In use to connect user circuit to a backplane using the connector of U.S. Pat. No. 7,625,134, initially the connector is brought into proximity of a connecting portion of a backplane and a first stage of movement is required to align the connector on the user circuit and that on the backplane. Then a second stage of movement is undergone by which the flexibly mounted connector is moved in a plane perpendicular to the plane of the connector or user circuit itself. Thus, the connection is a two stage process. Although this works well, there is a desire to provide a connector in which a simpler connecting method can be achieved.

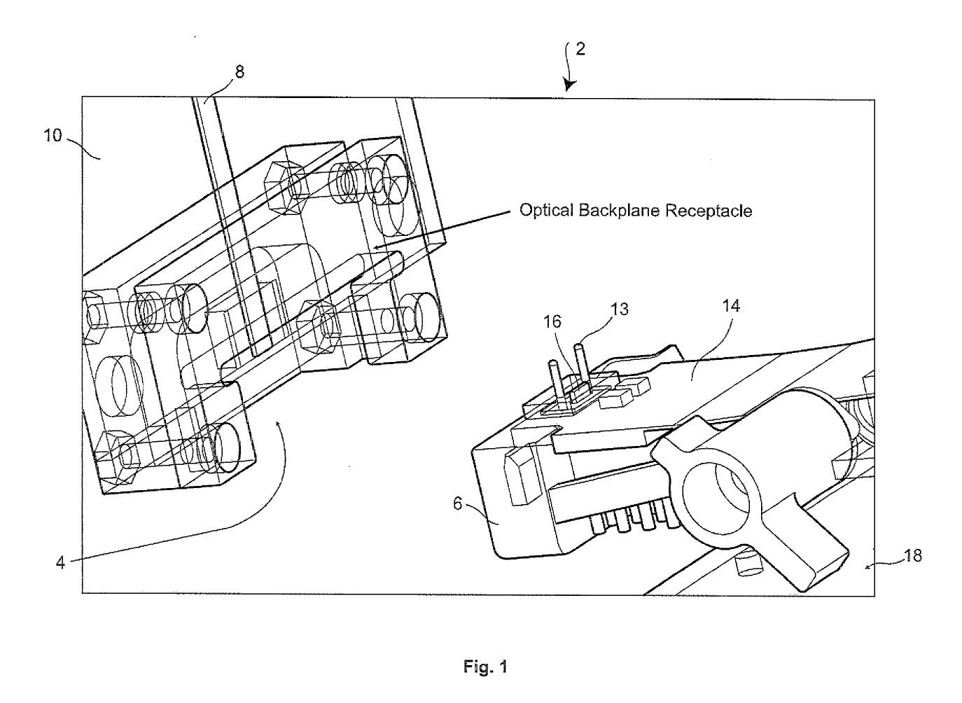

FIG. 1 is the same as FIG. 1 of U.S. Pat. No. 7,625,134 and it shows a connector as disclosed in U.S. Pat. No. 7,625,134. The connector 2 includes an optical backplane receptacle 4 provided fixed on a backplane 10 and arranged to mate with a connector unit 6 on a user circuit 18. A group of optical waveguides 8 are provided on the backplane 10. A flexible component 14 is provided which typically might be a piece of flexible PCB such as kapton polyimide. An optical interface unit 16 is provided on the connector and is arranged in use to provide a route for optical signals from the user circuit 18 to the waveguides 8 on the backplane. A movable component 17 is arranged to enable the connector unit 6 on the user circuit to be moved in a direction perpendicular to the major plane of the user circuit 18 for engagement with an optical interface in the optical backplane receptacle 4 on the backplane 10.

It will be appreciated that currently, in order to provide a pluggable connection to an optical printed circuit board one must either use an out-of-plane or an in-plane optical interface. In an “in-plane interface”, light is launched from (or received into) the interface directly from a waveguide without any redirecting of the light. In contrast, in an “out-of-plane” there is typically provided some means to redirect the light. For example, an angled mirror might be provided to divert light at right-angles from the connector interface into the waveguides of the optical PCB. A problem with this approach is the cost of the right-angled mirror and its alignment and assembly onto the embedded waveguides in the optical PCB or on the connecting interface and the additional optical loss incurred across the interface. The optical loss budget on an optical PCB can be a critical issue and, generally, should be minimised wherever possible.

As described above with reference to the system of U.S. Pat. No. 7,625,134, the in-plane optical interface up to now has required a connector mechanism to move the optical platform orthogonally with respect to the direction of insertion of the user circuit into the backplane in order to stop the mechanical registration features from catching. Referring to FIG. 1, registration features 13 are provided that ensure alignment between the optical interface on the user circuit and the waveguides embedded in the backplane. These project out of the plane of the user circuit and therefore there is a risk that they would foul the edge of the backplane upon engagement of the user circuit with the backplane. It has not been possible to create a directly pluggable connector to an in-plane interface without such a mechanism. The advantage of an in-plane interface is that coupling components (e.g. microlens arrays) do not include minors or other deflection structures and are thus cheaper and incur less optical loss.

In our granted U.S. Pat. No. 7,490,993, the entire contents of which are hereby incorporated by reference, there is disclosed an adapter for an optical printed circuit board. The adapter includes a socket for receiving a user circuit for connecting to an optical printed circuit board and a connector for engagement with the optical printed circuit board. The adapter is arranged such that when the connector engages with the optical printed circuit board an optical connection is established between the optical printed circuit board and the adapter.

According to a first aspect of the present invention, there is provided an in-plane optical connector for connecting a user circuit to an optical backplane, the connector comprising: a first optical interface provided on the user circuit for receiving optical signals from the backplane or for transmitting optical signals to the backplane; a second optical interface arranged for connection on a backplane for receiving optical signals from the user circuit or for transmitting optical signals to the user circuit; alignment features provided on each of the user circuit and the backplane arranged to align the first and second optical interfaces upon engagement of the user circuit with the backplane using movement in a single direction.

In contrast to known systems, such as that disclosed in U.S. Pat. No. 7,625,134 and described above, the connector of the present invention is configured such that a user circuit can be optically connected to a backplane with movement in a single direction. There is no need, as there was previously, for a double stage engagement process, i.e. in which first the optical interfaces were brought into vertical alignment and then they were moved to ensure horizontal alignment. Rather, moving the connector housing on the user circuit in a single direction will ensure optical engagement between the user circuit and the backplane. Thus, the system is easy and convenient to use for an end user.

In one embodiment, the direction is orthogonal to the backplane. Thus the user can intuitively connect a user circuit to an optical backplane simply by plugging it in, in the way he would have plugged an electronic user circuit to an electronic backplane. The direction may be parallel to the plane of the user circuit which might or might not be orthogonal to the backplane.

In one embodiment, the connector comprises a first housing for the optical interface provided on the user circuit and a second housing for the optical interface provided on the backplane, the first and second housings comprising the alignment features. The housings take advantage of the MT slots in conventional MT interfaces such as the microlens array to align the optical interface to themselves.

In an embodiment, the alignment features comprise rails provided on one of the first and second housings and grooves sized to receive the rails provided on the other of the first and second housings. Preferably, the grooves or rails have stops to limit the relative translational movement and thereby determine alignment in the axis parallel to the direction of insertion of the user circuit (henceforth vertical) between the first and second optical interfaces.

In a preferred embodiment, in which the rails are provided on the first housing and the grooves are provided on the second housing and the grooves have a tapered profile, with the cross section of the opening to the grooves being larger than the cross section of the remaining portion of the grooves. This makes it easy and convenient for user to initially engage the user circuit with the backplane because the openings are larger than actually required. However, the tapered profile means that as the rails move along the grooves during insertion, the tolerance reduces until eventually there is a good fit so as to ensure alignment between the optical interfaces in the axis perpendicular to the direction of user circuit insertion but parallel to the plane of the optical interfaces (henceforth horizontal).

In an embodiment, the alignment features are sized to ensure accurate alignment of the optical interfaces on each of the backplane and the user circuit. In other words, the grooves and the rails are sized to ensure that the optical interfaces accurately align upon engagement. Preferably stops are provided on one or both of the grooves or rails, or more generally on the alignment features, to ensure correct vertical alignment between the two optical interfaces.

In a preferred embodiment the stops comprise projections at the end or bottom of the grooves to limit the translational movement of the rails in the grooves. Preferably the stops do not fully enclose the rails so that any dirt or foreign material that is present in the rails can easily be removed. More preferably the stops have sloped surfaces so that dirt or foreign material is not encouraged to gather on them.

In one embodiment, the or each of the optical interfaces comprises a microlens array. The microlens array may be an array of Graded Index lenses or geometric lenses.

In one preferred embodiment, when the user circuit is connected to the backplane a spacing exists between the first and second optical interfaces. Thus there is no physical contact between the actual outer surfaces of the lenses such that the risk of damage is minimised. By ensuring that there is a spacing between the optical interfaces when in engaged configuration, the risk of scratching or other forms of physical damage is reduced.

According to a second aspect of the present invention, there is provided a method of connecting an optical user circuit having a first optical interface to an optical backplane having a second optical interface, in which the backplane has one or more waveguides on it for carrying optical signals, the method comprising; engaging alignment features provided on the user circuit with corresponding alignment features provided on the backplane so as to enable alignment between the first and second optical interfaces, moving the user circuit in a single direction to connect it optically in-plane to the backplane.

A simple and robust method is provided by which a user can connect a user circuit in-plane to an optical backplane.

In one embodiment, the single direction is orthogonal to the backplane or parallel to the plane of the user circuit. This means that a user can simply and intuitively plug a user circuit into a backplane as if the device were a conventional electrical device and not optical, whilst still ensuring that good optical alignment will be achieved.

In one embodiment, the alignment features comprise grooves provided in one of the first and second housings and rails provided in the other of the housings and in which the moving of the user circuit in a single direction to connect it optically to the backplane comprises putting the rails in the grooves and pushing the user circuit until a stop position is reached.

In one aspect, there is provided an optical connector for connecting a user circuit to an optical backplane, in which the backplane has one or more waveguides on it for carrying optical signals, the connector comprising: a first optical interface provided on the user circuit for receiving optical signals from the backplane or for transmitting optical signals for passage along the one or more waveguides; a second optical interface provided on the backplane for receiving optical signals from the user circuit or for transmitting optical signals to the user circuit; and alignment features provided on each of the user circuit and the backplane arranged to align the first and second optical interfaces such that upon insertion of the user circuit to the backplane, the optical interfaces are aligned in the direction of insertion.

Thus, the invention, in embodiments, provides a means of achieving an orthogonal connection to an in-plane optical interface, but without pins (or other salient registration features) so that the transceiver or optical interface can be plugged simply and directly without the need for a complex engagement mechanism to pull and push the optical interface (on the transceiver platform) in a direction orthogonal to the direction of insertion in order to stop the pins catching.

A method of plugging optical devices orthogonally into an optical PCB with an in-plane waveguide interface is provided that, in preferred embodiments, uses vertical alignment rails and grooves. High precision components incorporating the alignment features, may also be provided which incorporate registration features to allow assembly to standard MT/MPO compliant optical interfaces e.g. microlens arrays.

In embodiments the invention allows direct pluggability of an optical device into an optical PCB with an in-plane waveguide interface without the need for a secondary engagement mechanism. Thus, the connector can be provided at lower cost yet have a more reliable method of engaging to an in-plane waveguide interface.

According to a third aspect of the present invention, there is provided an optical connector for a user circuit, for connecting a user circuit to an optical backplane, the connector comprising: an optical interface provided on the user circuit for receiving optical signals from the backplane or for transmitting optical signals to the backplane; alignment features provided on the user circuit arranged to engage with alignment features provided on the backplane, to align the optical interface on the user circuit with an optical interface provided on the backplane upon engagement of the user circuit with the backplane, using movement in a single direction.

According to a fourth aspect of the present invention, there is provided an optical connector for an optical backplane for enabling connection of a user circuit to the said optical backplane, the connector comprising: a first optical interface provided on the backplane for receiving optical signals from the user circuit or for transmitting optical signals to the user circuit; alignment features provided on the connector arranged to engage with alignment features provided on the user circuit, to align the optical interface on the backplane with an optical interface provided on the user circuit upon engagement of the user circuit with the backplane, using movement in a single direction.

A connector is provided for a user circuit or a backplane that can be used with a corresponding connector provided on a backplane or a user circuit and that enables easy and robust connection of a user circuit with an optical backplane using movement in a single direction only. In other words a simply pluggable usable circuit is enabled.

Embodiments of the present invention will now be described in detail with reference to the accompanying drawings, in which:

FIG. 1 is a representation of a connector as disclosed in U.S. Pat. No. 7,625,134;

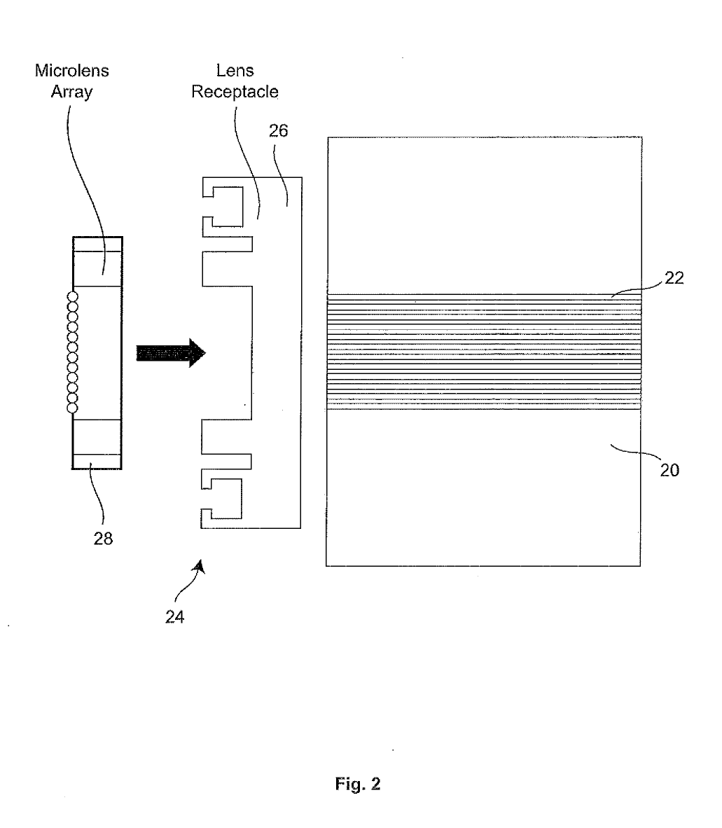

FIG. 2 is a representation of components of a connector;

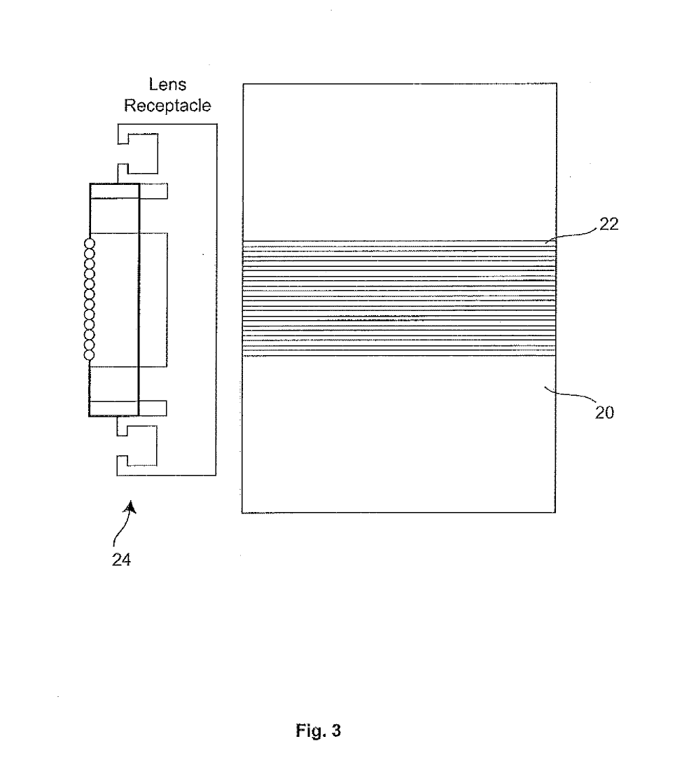

FIG. 3 is a schematic representation of the connector of FIG. 2 in a part-assembled state;

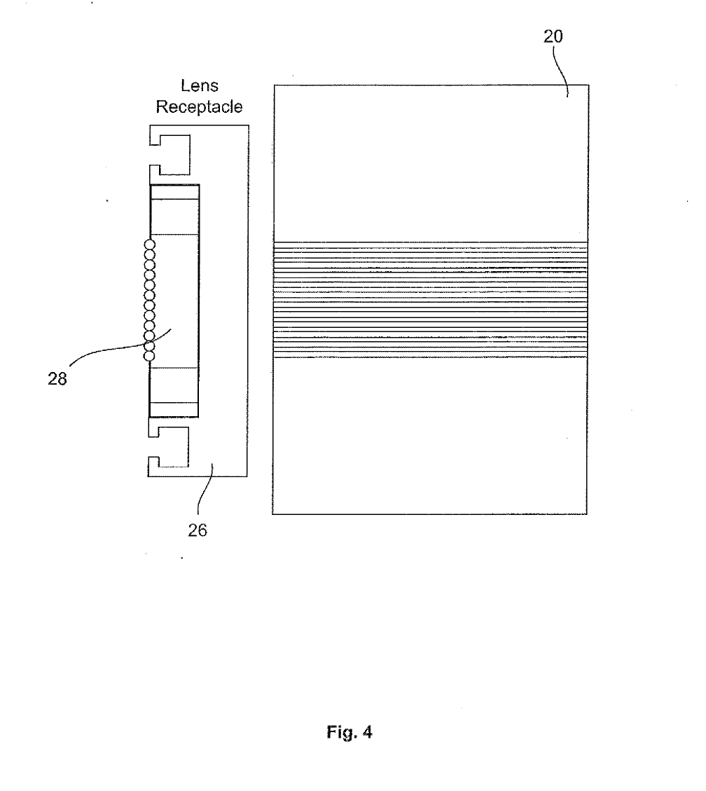

FIG. 4 is a schematic representation of the connector of FIG. 3 in an assembled state;

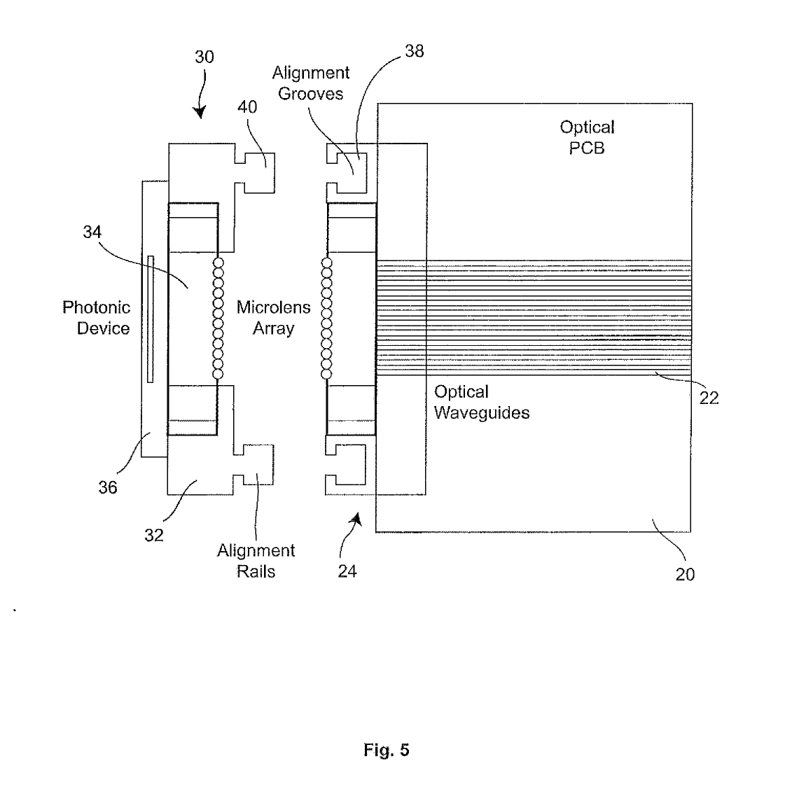

FIG. 5 is a schematic representation of a connector including an optical backplane and a user circuit connector;

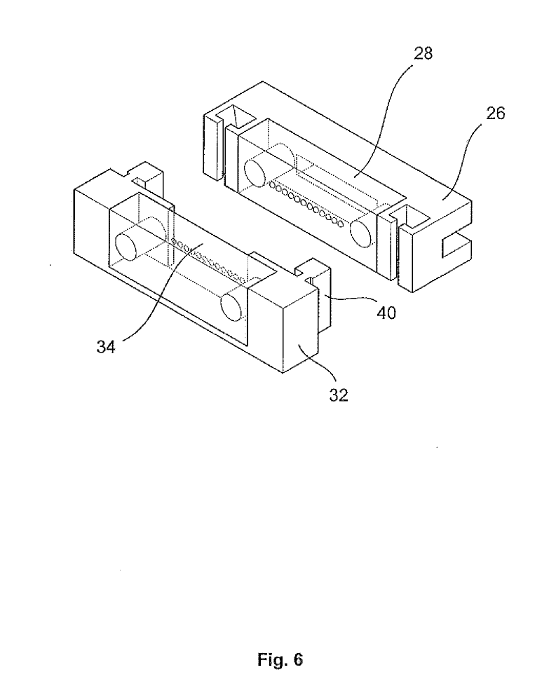

FIG. 6 is a perspective view of the connector of FIG. 5;

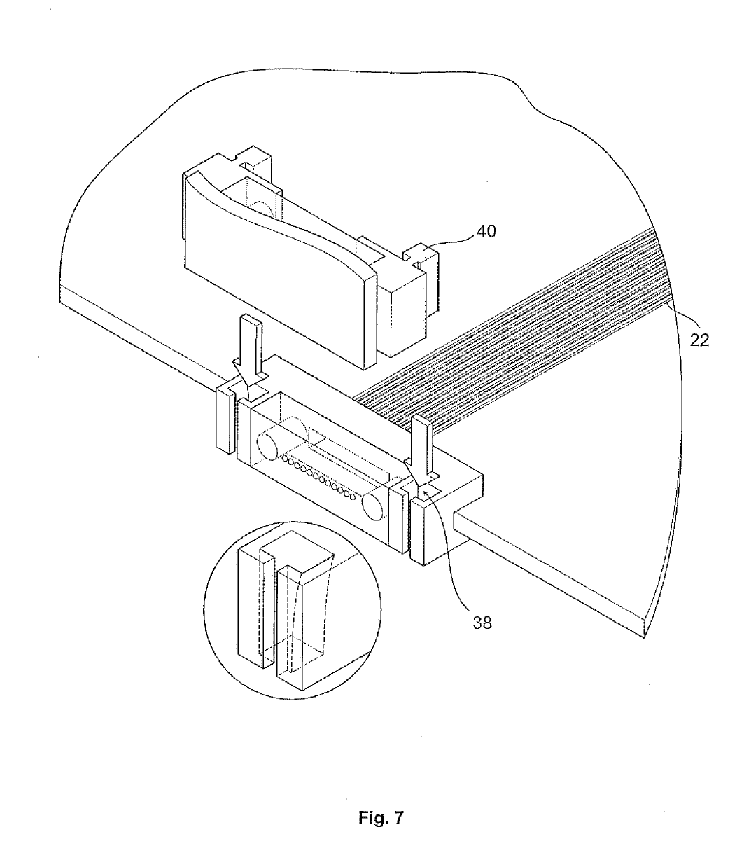

FIG. 7 is a perspective view of the connector of FIG. 6 assembled to a backplane;

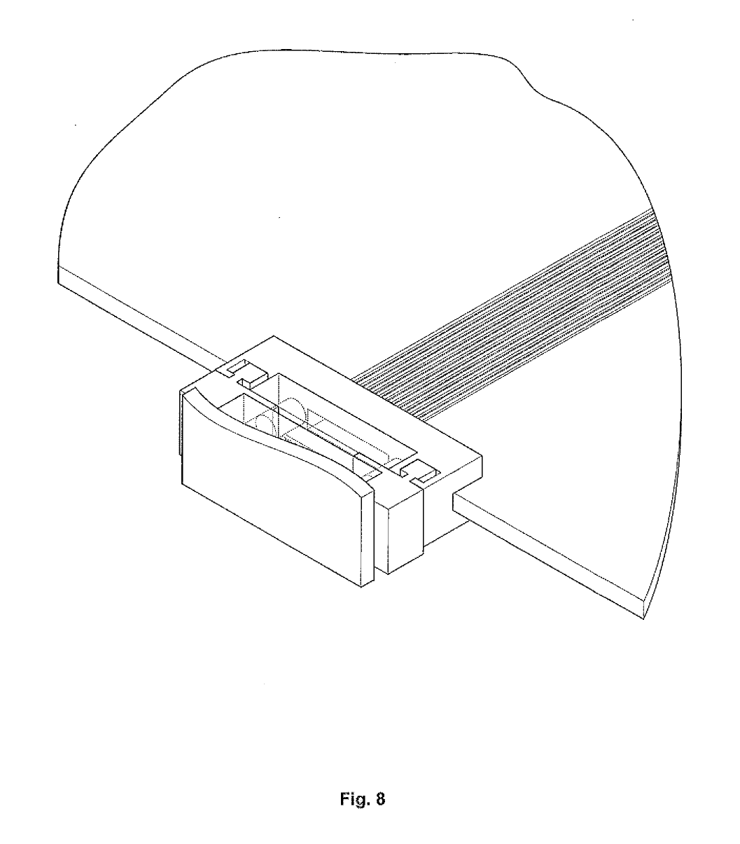

FIG. 8 is a schematic perspective view of a backplane and a user circuit connected with the connector of FIGS. 6 and 7;

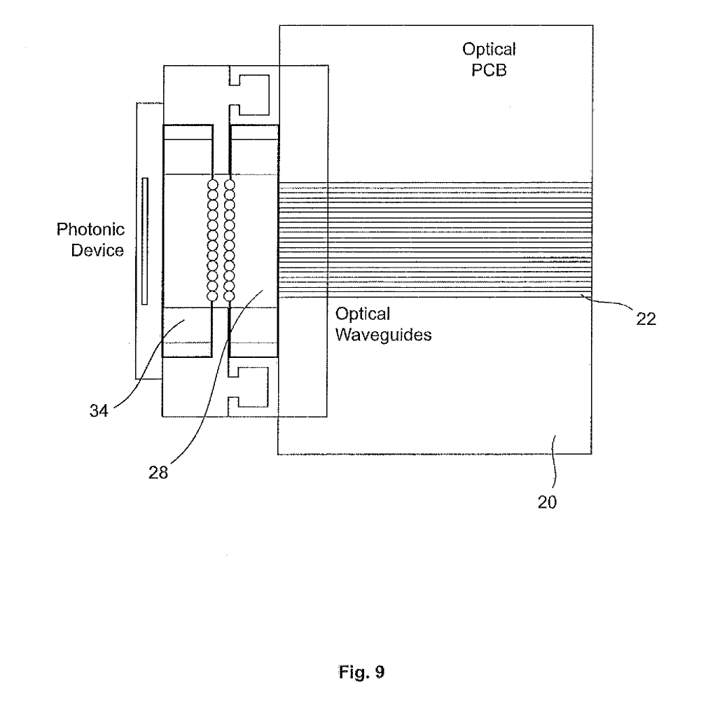

FIG. 9 is a schematic representation of a horizontal section through the connector of FIG. 8;

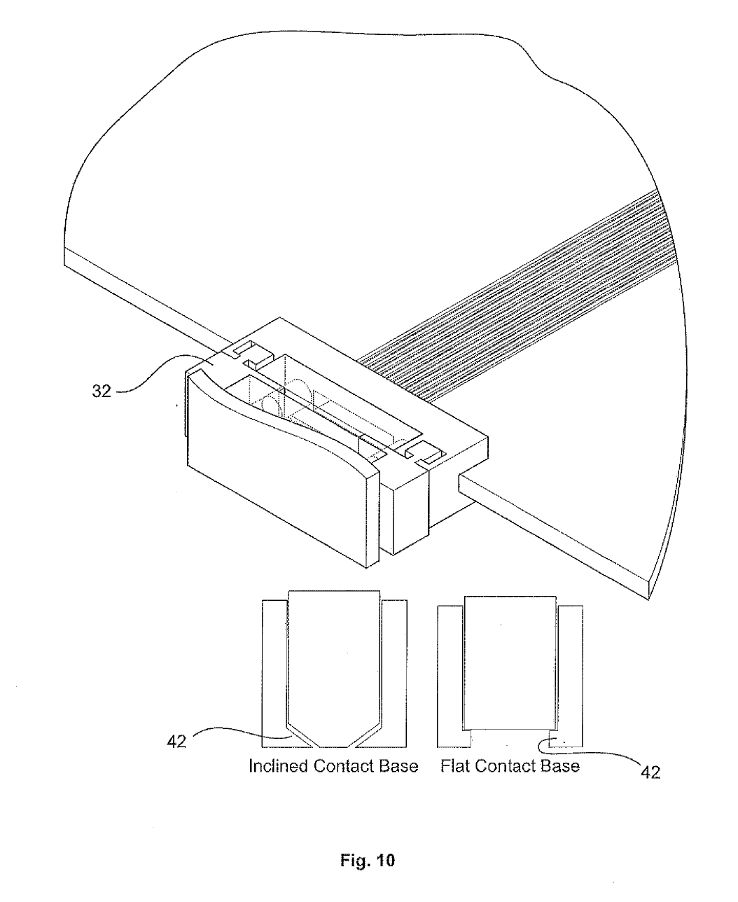

FIG. 10 is a schematic representation of the connector alignment feature of the connector of FIG. 8;

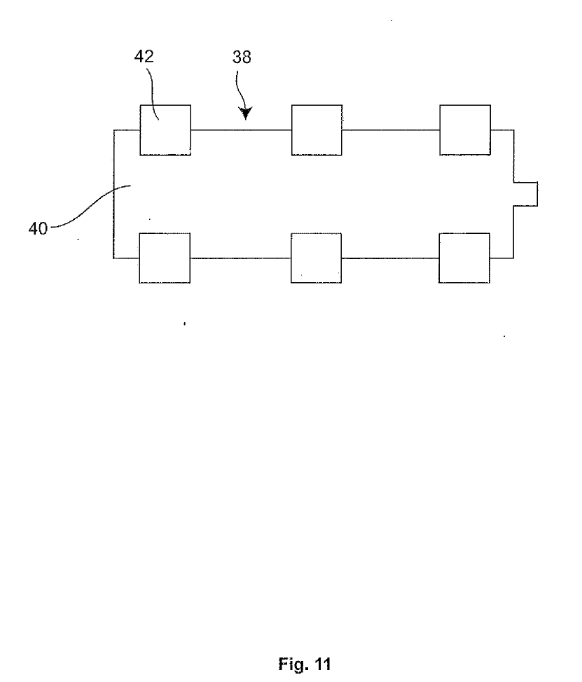

FIG. 11 is a schematic underside plan view of the alignment features of the connector of FIG. 8; and

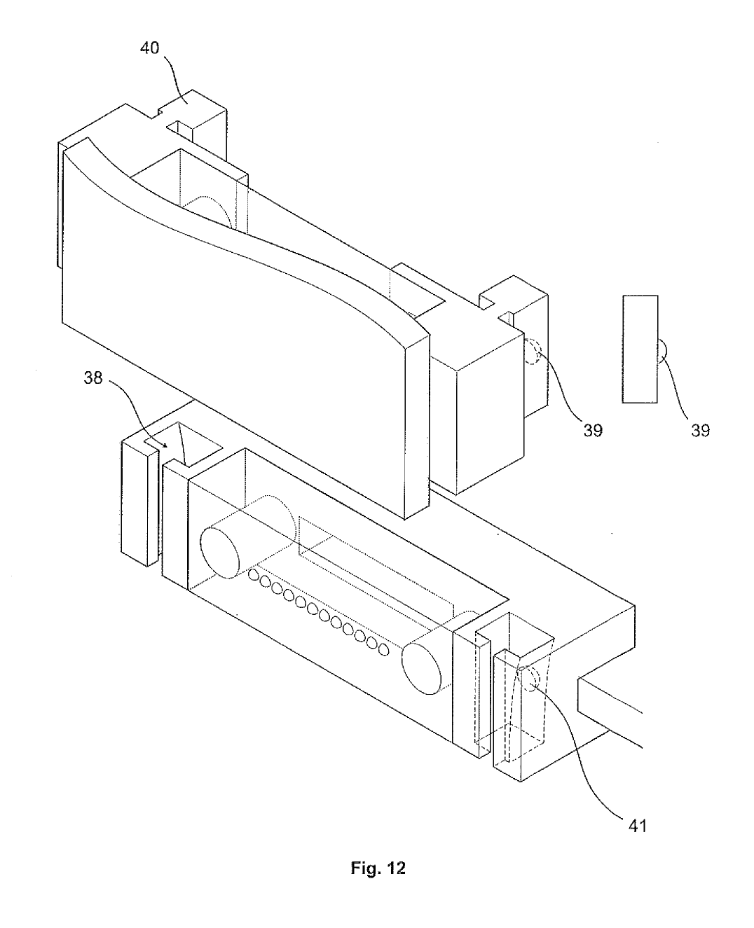

FIG. 12 is a schematic view of a connector including alignment features.

FIG. 2 shows a schematic representation of components of a connector 24 as might be provided coupled to a backplane. The backplane 20 has a number of optical waveguides 22 provided thereon. Parts of the connector 24 as would be provided on the backplane include a backplane mount 26 which functions as a lens receptacle. A microlens array 28 is provided for assembly with a backplane mount. Typically, the mount is sized and shaped so as to take advantage of the MT slots in a conventional MT interface such as the microlens array 28 to align the optical interface to themselves.

FIG. 4 shows a schematic representation of the device of FIG. 2 in which the lens array 28 is arranged within the lens receptacle or backplane mount 26.

Referring now to FIG. 5, there is shown the entire connector. The entire connector includes both the parts 24 provided on the backplane and the parts provided on the user circuit. The connection between the backplane mount 26 and the backplane 20 is preferably a fixed connection. A second part of the connector, referred to as the user circuit mount 30 is provided. In use, the part of the user circuit mount 30 would typically be provided coupled to a user circuit such as a hard disk drive or any other suitable device. The user circuit mount 30 comprises an engagement housing 32 together with a microlens array 34. The microlens array 34 is arranged such that, in use, when the engagement housing 32 is connected to the backplane mount 26 (as will be described in detail below) the lenses of the microlens array 34 are aligned with the lenses of the microlens array 28 provided within the backplane mount 26. Thus, light can be transferred in a controlled and reliable manner between the optical waveguides 22 and the microlens array 34. From the microlens array 34, light can then pass to components on the user circuit (not shown).

In some embodiments, the optical interface unit or engagement housing 32 is active, meaning that it is arranged to receive electrical signals from components on the user circuit and then to generate the light signals within the connector itself. In the example shown in FIG. 5, a photonic device 36 is provided which is arranged to receive as inputs from the user circuit, electrical signals which are used to control the photonic device 36 to generate optical signals for transmission through the microlens array 34 on the user circuit and into the microlens array 28 on the backplane.

In another example, the engagement housing 32 might include a passive optical interface as opposed to an active optical interface. If a passive optical interface is provided, then no active photonic device would be provided, but instead, a passive optical component, such as a fibre-optic cable, is provided which is arranged to receive optical signals and couple these to the optical waveguides 22. In other words, instead of generating the optical signals within the connector, the optical signals would be generated elsewhere and provided to the connector as optical signals already. This contrasts with the active device in which the optical signals are generated on the connector itself.

The receptacle housings 24 and 32 each include alignment features. In one non-limiting example, alignment grooves 38 are provided within the unit 24 and corresponding alignment rails 40 are provided as part of the engagement housing 32. The grooves could be provided as part of the engagement housing 32 and rails could be provided within the unit 24.

In order to meet the tight alignment tolerances required to reliably connect an optical interface on a user circuit or line card to an embedded optical waveguide interface in a PCB such as a backplane, high precision registration features on both elements must be mated.

The registration features 38 and 40 provided on the backplane and the engagement housing 32 on the user circuit respectively, are aligned in the direction of insertion, as opposed to in the direction orthogonal to the direction of insertion as in U.S. Pat. No. 7,625,134 discussed above. Thus, an optical device on a user circuit may mate directly, without the need for a secondary engagement step.

In a preferred example, the registration features are made up of rails on one of the elements and compliant alignment grooves on the other. When an optical device on a line card or user circuit engages with the connector 24 as might be provided coupled to a backplane 20, the rails 40 on the optical device slot into the grooves 38 of the receptacle. Once insertion is complete, the optical interface of the user circuit device and the waveguide interface on the backplane or PCB 20 are accurately aligned to each other.

The optical interfaces on both the user circuit and the backplane or PCB 20 usually comprise a microlens array such as geometric lenses, graded index (GRIN) lenses or other suitable components, which are commercially available. Most available parallel optical components are designed around the MT/MPO standard and will have registration features such as alignment pins or slots built into them. One preferred example is the Omron® P1L12A-C1 flat microlens array, wherein two slots are machined within a tight tolerance on either side of an array of twelve microlenses. These features can be used to passively assemble the lens onto a custom high precision plastic component, which incorporates alignment rails or grooves. In one example as shown in FIGS. 2 to 4, the plastic lens holders incorporate stubs, which allow the microlens arrays to be slotted into them. As these same components include the alignment rails and grooves, these features will be accurately located relative to the optical channels 22 on the PCB 20.

It is preferred that the optical interfaces, i.e. the lens arrays 28 and 34 on the PCB 20 and the engagement housing 32 respectively are not in physical contact, but rather are provided very close to each other. In other words, there is free space between the lenses of the array 34 and the array 28. This way, damage to both lens arrays will be avoided when one effectively slides over or past the other during the engagement and disengagement process. FIG. 9 shows this clearly in that there is a space between the lenses on the microlens array 34 connected to the user circuit and the microlens array 28 connected to the PCB 20.

FIGS. 6 to 8 show in perspective, how the connector units with the microlens arrays might typically be provided and arranged to mate in use. Referring to FIG. 7, a user circuit is simply “plugged” into the backplane 20 by slotting the rails 40 into the grooves 38. The positioning of the grooves 38 and rails 40 and also the microlens arrays within the backplane mount 26 and the engagement housing 32, respectively ensures horizontal alignment between the lenses of the two arrays. In other words, in a horizontal plane, or rather the plane of the PCB 20, the lenses are aligned. However, it is also necessary to ensure alignment in the vertical plane, i.e. in the plane of the user circuit itself. To achieve this, alignment features are provided as part of the backplane mount 26.

FIGS. 10 and 11 show schematic representations of how alignment projections might operate. Referring to FIG. 11, which shows a schematic plan view from below of one of the rails 40 arranged within the corresponding groove 38, it can be seen that projections 42 are provided which effectively limit the downwards movement of the engagement housing 32. In other words when the engagement housing 32 is brought into mating engagement with the backplane mount, 26 on the PCB 20, the vertical alignment of the two is ensured by the positioning of the alignment features 42. The alignment features 42 serve to limit the movement of the rails in the grooves and thus of the user circuit and the engagement housing 32.

Though lateral alignment tolerance of the alignment rails in the alignment grooves is relatively straightforward to achieve, vertical alignment tolerance is more susceptible to contamination, which will affect how the alignment rails “sit” on the alignment features 42 within the alignment grooves. These grooves may be prone to contamination like all other components in the system and residue will build up quickly on the bottom of the grooves as in any recess from where it cannot be easily dislodged.

As shown in FIGS. 10 and 11, to avoid the build up of residue, the base of the groove will be open and comprises small outcrops or features 42 upon which the alignment rail can sit securely, as opposed to a complete “floor”. Residue is therefore less likely to gather and any transient contamination can easily be dislodged. In particular, since the channel of the grooves 38 is effectively open, airflow can be provided within the groove to dislodge any contaminant material. Simply blowing on the connection will clear the opening or alternatively it can be cleaned with a suitable cleaning implement.

Two preferred examples for the alignment features 42 are shown in FIG. 10. In one embodiment, the outcrops are flat, i.e. perpendicular to the axial walls of the groove and in another, they are inclined to the axial walls of the groove so as to further reduce contamination. By providing an inclined surface of the groove, any contaminant material is encouraged, by gravity or by blowing or other such cleaning or by the action of the engagement itself, to fall out of the groove as soon as it is generated.

In a preferred embodiment a feature may be provided to increase or improve vertical alignment. This is shown in FIG. 12. One or more small hemispherical nubs or projections 39 are provided on the alignment rails 40 and compliant hemispherical holes or recesses 41 are provided in the alignment groove 38 (or vice versa) so that when plugged in the dongle smoothly clicks into place as the hemispherical holes and nubs engage, i.e. are slotted into each other. The nub is sufficiently small and smooth so the device does not catch as the connector is plugged in. The interface is simply pushed slightly back as the stub is pulled out of its hole. Although described as hemispherical it will appreciated that any suitably contoured surface may be used for the outer dimensions of the nubs, the holes being correspondingly shaped.

FIG. 7 shows one important preferable feature of the backplane mount 26. This is that the alignment grooves 38 have a tapered profile in that the opening is wider than the bottom. This means that it is easy for a user to initially get the alignment rails 40 into the grooves 38 and then as the movement into the final resting place of the engagement housing 32 is accomplished, the tolerance and clearance reduces so as to ensure accurate alignment. Preferably, there is a region of the groove towards the lower end thereof which is not tapered at all. It is this untapered region which can define the precise alignment of the lens array 34 with the lens array 28 on the optical PCB 20.

Thus, the present system provides a means of achieving an orthogonal connection to an in-plane optical interface, without alignment pins as required in U.S. Pat. No. 7,625,134. Furthermore, there are no moving parts required in the connector which means that it is not prone to damage or failure as compared to known systems. The transceiver or optical interface can be plugged simply and directly without the need for a complex engagement mechanism to pull and push the optical interface on the transceiver platform in a direction orthogonal to the direction of insertion, in order to achieve the lateral engagement without the pin fouling the optical PCB connector.

Embodiments of the present invention have been described with particular reference to the examples illustrated. However, it will be appreciated that variations and modifications may be made to the examples described within the scope of the present invention.

1. An in-plane optical connector for connecting a user circuit to an optical printed circuit board, the connector comprising:
a first optical interface provided, in use, on a said user circuit for receiving optical signals from the optical printed circuit board or for transmitting optical signals to the optical printed circuit board;
a second optical interface arranged, in use, for connection on an optical printed circuit board for receiving optical signals from the user circuit or for transmitting optical signals to the user circuit;
alignment features provided, in use, on each of the user circuit and the optical printed circuit board arranged to align the first and second optical interfaces upon engagement of the user circuit with the optical printed circuit board using movement in a single direction.

2. An optical connector according to claim 1, in which the direction is orthogonal to the optical printed circuit board.

3. An optical connector according to claim 1, in which the direction is parallel to the plane of the user circuit.

4. An optical connector according to claim 1, comprising a first housing for the optical interface provided on the user circuit and a second housing for the optical interface provided on the optical printed circuit board, the first and second housing comprising the alignment features.

5. An optical connector according to claim 4, in which the alignment features comprise rails provided on one of the first and second housings and grooves sized to receive the rails provided on the other of the first and second housings.

6. An optical connector according to claim 5, in which the grooves or rails have stops to limit the relative translational movement and thereby determine alignment between the first and second optical interfaces.

7. An optical connector according to claim 6, in which the rails are provided on the first housing and the grooves are provided on the second housing in which the grooves have a tapered profile, with the cross section of the opening to the grooves being larger than the cross section of the remaining portion of the grooves.

8. An optical connector according to claim 4, in which first and second housings include alignment features to prealign standard optical interfaces.

9. An optical connector according to claim 8, in which the alignment features are alignment stubs to allow the lenses to be assembled accurately within the housings.

10. An optical connector according to claim 1, in which the alignment features are sized to ensure accurate alignment of the optical interfaces on each of the optical printed circuit board and the user circuit.

11. An optical connector according to claim 1, in which the or each of the optical interfaces comprises a microlens array.

12. An optical connector according to any of claim 11, in which microlens array is an array of graded index lenses or geometric lenses.

13. An optical connector according to claim 4, in which the or each of the housings is compatible to receive an MT or MPO ferrule.

14. An optical connector according to claim 1, in which, when the user circuit is connected to the optical printed circuit board a spacing exists between the first and second optical interfaces.

15. An optical connector according to claim 5, comprising alignment stubs provided on one of the grooves and rails and correspondingly shaped alignment recesses provided on the other of the grooves and rails so as to ensure accurate vertical alignment between the first and second interfaces.

16. A method of in-plane connecting an optical user circuit having a first optical interface to an optical printed circuit board having a second optical interface, in which the optical printed circuit board has one or more waveguides on it for carrying optical signals, the method comprising;
engaging alignment features provided on the user circuit with corresponding alignment features provided on the optical printed circuit board so as to enable alignment between the first and second optical interfaces, moving the user circuit in a single direction to connect it optically to the optical printed circuit board.

17. A method according to claim 16, in which the single direction is orthogonal to the optical printed circuit board or parallel to the plane of the user circuit.

18. A method according to claim 16, in which the alignment features comprise grooves provided in one of the first and second housings and rails provided in the other of the housings and in which the moving of the user circuit in a
single direction to connect it optically to the optical printed circuit board comprises putting the rails in the grooves and pushing the user circuit until a stop position is reached.

19. An in-plane optical connector for a user circuit, for connecting a user circuit to an optical printed circuit board, the connector comprising:
an optical interface provided on the user circuit for receiving optical signals from the optical printed circuit board or for transmitting optical signals to the optical printed circuit board;
alignment features provided on the user circuit arranged to engage with alignment features provided on the optical printed circuit board, to align the optical interface on the user circuit with an optical interface provided on the backplane upon engagement of the user circuit with the optical printed circuit board, using movement in a single direction.

20. An in-plane optical connector for an optical printed circuit board for enabling connection of a user circuit to the said optical printed circuit board, the connector comprising:
a first optical interface provided on the optical printed circuit board for receiving optical signals from the user circuit or for transmitting optical signals to the user circuit;
alignment features provided on the connector arranged to engage with alignment features provided on the user circuit, to align the optical interface on the optical printed circuit board with an optical interface provided on the user circuit upon engagement of the user circuit with the optical printed circuit board, using movement in a single direction.

21. An optical connector according to claim 1, in which the optical printed circuit board is an optical backplane.

22. An optical connector according to claim 19, in which the optical printed circuit board is an optical backplane.

23. An optical connector according to claim 20, in which the optical printed circuit board is an optical backplane.
